(19) United States
(12) Patent Application Publication
(10) Pub. No.: US 2014/0369187 A1
(43) Pub. Date: Dec. 18, 2014

(54) Cellular In-Device Coexistence (IDC) Advanced Coexistence Algorithm

(71) Applicant: Broadcom Corporation, Irvine, CA (US)

(72) Inventors: Aimin Justin Sang, San Diego, CA (US); Kamesh Medapalli, San Jose, CA (US)

(21) Appl. No.: 13/916,221

(22) Filed: Jun. 12, 2013

(51) Int. Cl. H04L 12/801

(52) U.S. Cl. CPC H04L 47/14
USPC 370/229

(57) ABSTRACT

Systems and methods for enabling in-device coexistence (IDC) are provided. In an embodiment, IDC interference is detected and determination is made whether or not the IDC interference can be remedied using an internal user equipment (UE) solution that does not involve the cellular network. If not, a preferred IDC solution is determined by the UE and sent to the cellular network in an IDC indication. The cellular network responds to the IDC indication with a network-identified IDC solution, which may or may not correspond to the preferred IDC solution. The UE can apply the network-identified IDC solution to remedy the IDC interference.

### FIELD OF THE INVENTION

The present disclosure relates generally to cellular in-device coexistence (IDC) interference.

### BACKGROUND

### Background Art

The increasing demand for multiple applications or services in a single communications device presents an increasing need for the coexistence of multiple collocated radio technologies within the communications device. This means that the multiple collocated radio technologies need to operate with manageable interference to one another despite their physical proximity, spectral closeness, and/or imperfect radio frequency (RF) filtering.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example communications device according to an embodiment.

FIG. 2 illustrates an in-device coexistence (IDC) interference related process defined by the 3^{rd} Generation Partnership Project (3GPP).

FIG. 3 illustrates an example communications processor according to an embodiment.

FIG. 4 illustrates another example communications processor according to an embodiment.

FIG. 5 illustrates example Bluetooth (BT) transmit-receive (TX/RX) modes.

FIG. 6 illustrates an example Discontinuous Reception (DRX) pattern configuration solution for an example Long Term Evolution (LTE) and BT application scenario according to an embodiment.

FIG. 7 is an example process according to an embodiment.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

In the following disclosure, terms defined by the Long-Term Evolution (LTE) standard are sometimes used. For example, the term “eNodeB” or “eNB” is used to refer to what is commonly described as a base station (BS) or a base transceiver station (BTS) in other standards. The term “User Equipment (UE)” is used to refer to what is commonly described as a mobile station (MS) or mobile terminal in other standards. However, as will be apparent to a person of skill in the art based on the teachings herein, embodiments are not limited to the LTE standard and can be applied to other cellular communication standards (e.g., Evolved High-Speed Packet Access (HSPA+), Wideband Code Division Multiple Access (W-CDMA), CDMA2000, Time Division-Synchronous Code Division Multiple Access (TD-SCDMA), Global System for Mobile Communications (GSM), General Packet Radio Service (GPRS), Enhanced Data Rates for GSM Evolution (EDGE), Worldwide Interoperability for Microwave Access (WiMAX), etc.). Further, embodiments are not limited to cellular communication networks and can be used or implemented in other kinds of wireless communication access networks (e.g., wireless local area network (WLAN), Bluetooth (BT), etc.).

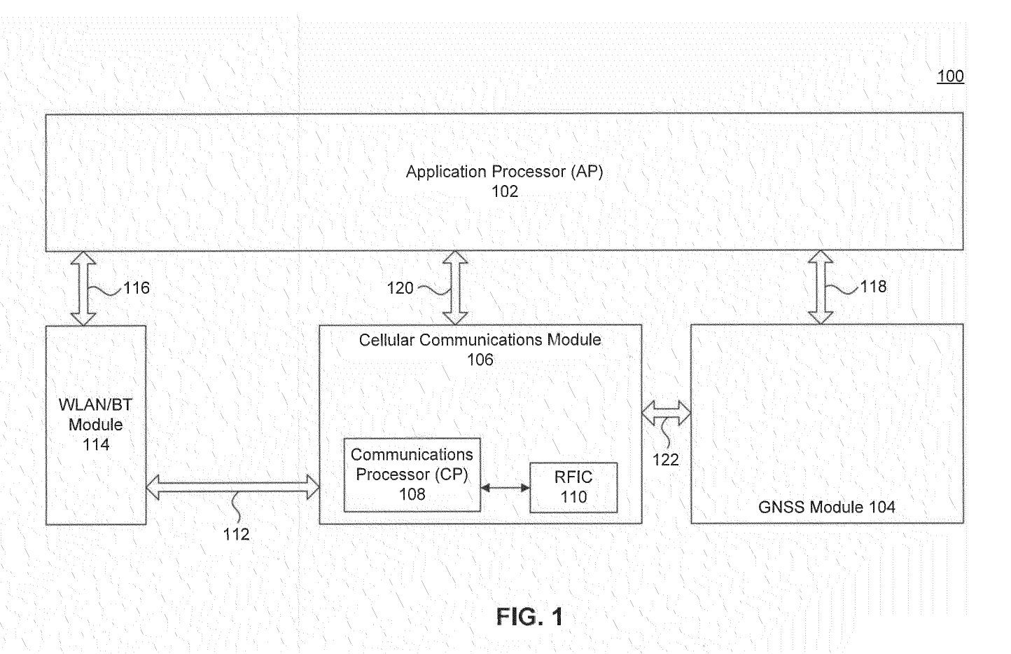

FIG. 1 illustrates an example communications device 100 according to an embodiment. Example communications device 100 is provided for the purpose of illustration and is not limiting of embodiments of the present disclosure. Communications device 100 may be a smart phone, tablet, or personal computer (PC), for example, which enables data communication (e.g., Internet access, email, smart phone applications, etc.) as well as voice calling. Communications device 100 may support various cellular communication technologies including, without limitation, LTE, HSPA+, W-CDMA, CDMA2000, TD-SCDMA, GSM, GPRS, EDGE, and WiMAX, for example.

As shown in FIG. 1, communications device 100 includes an application processor (AP) 102, a Global Navigation Satellite System (GNSS) module 104, a cellular communications module 106, and a WLAN/BT module 114.

AP 102 can enable various Internet Protocol (IP)-based applications, including data, audio (e.g., voice, streaming music, etc.), and/or video applications. To support these applications, AP 102 can implement various protocol stacks, including an “IP” stack, which includes the Transmission Control Protocol (TCP) and/or the User Datagram Protocol (UDP) over the Internet Protocol (IP). Further, AP 102 can enable various navigation applications and/or location-based services (LBS) applications. These navigation and/or location-based services (LBS) applications can be enabled by GNSS, cellular communication, and/or WLAN technologies, for example.

AP 102 can communicate with other modules of communications device 100. For example, as shown in FIG. 1, AP 102 can communicate with cellular communications module 106 via an interface 120, with GNSS module 104 via an interface 118, and with WLAN/BT module 114 via an interface 116. Interfaces 116, 118, and 120 can each be implemented as a Secure Digital Input/Output (SDIO) interface, a High-Speed-Inter-Chip (HSIC) interface, or a Universal Asynchronous Receiver/Transmitter (UART) interface, for example. In an embodiment, interface 116 includes a UART interface, interface 120 includes a HSIC interface, and interface 118 includes an SDIO interface. In an embodiment, AP 102 includes respective interface drivers (not shown in FIG. 1) to drive interfaces 116, 118, and 120.

In an embodiment, AP 102 can use cellular communications module 106 as a data link layer or Layer 2 (L2) pipe that provides L2 functions for IP-based traffic sent and received by AP 102. For example, L2 functions provided by cellular communications module 106 may include, without limitation, data link layer functions, Medium Access Control (MAC) layer functions, and Radio Link Control (RLC) functions. In addition, AP 102 can use cellular communications module 106 for baseband processing functions, including, without limitation, channel encoding/decoding, line coding/decoding, modulation/demodulation, etc. In an embodiment, the functions provided by cellular communications module 106 are particular to cellular communication technologies supported by cellular communications module 106.

Cellular communications module 106 includes one or more cellular communications modems, which can support a variety of cellular communications technologies, including, without limitation, LTE, HSPA+, W-CDMA, CDMA2000, TD-SCDMA, GSM, GPRS, EDGE, and WiMAX, for example. Cellular communications module 106 enables communications device 100 to communicate with a cellular network, and more particularly with a base station of the cellular network.

As shown in FIG. 1, cellular communications module 106 includes, without limitation, a communications processor (CP) 108 and a radio frequency integrated circuit (RFIC) module 110. As would be understood by a person of skill in the art, CP 108 can comprise one or more processors in implementation and is shown as a single module in FIG. 1 for simplification. Cellular communications module 106 can communicate directly with GNSS module 104 via an interface 122 and with WLAN/BT module 114 via an interface 112, or via AP 102.

CP 108 can include one or more processors or processing engines (e.g., Digital Signal Processing (DSP) engines), including, for example, a general controller processor/processing engine, a L2 protocol stack processor/processing engine, a baseband processor/processing engine, and a speech coding processor/processing engine.

The general controller processor includes a chip-level general controller of cellular communications module 106, which can perform general housekeeping functions, including boot up, configuration, and management functions within cellular communications module 106. The speech coding processor/processing engine implements various speech coding, including, for example, narrow-band, wide-band, and adaptive multi-rate speech coding functions, data compression functions, and/or acoustical processing functions, including noise suppression, echo cancellation, etc.

The L2 protocol stack processor/processing engine implements one or more L2 protocol stacks, including, for example, data link layer protocols, MAC layer protocols, and RLC protocols. L2 protocols are defined by cellular communications technologies and may be common to more than one technology. In an embodiment, as described above, the L2 protocol stack processor/processing engine provides an L2 data pipe for AP 102 via interface 120. The L2 protocol stack processor/processing engine may implement a variety of L2 protocol stacks in accordance with various cellular communications standards, including, for example and without limitation, LTE, HSPA+, W-CDMA, CDMA2000, TD-SCDMA, GSM, GPRS, EDGE, and WiMAX.

The baseband processor/processing engine implements baseband processing functions, including, without limitation, channel encoding/decoding, line coding/decoding, modulation/demodulation, etc. For example, the baseband processor/processing engine may implement a variety of baseband processing functions in accordance with various cellular communications standards, including, for example and without limitation, LTE, HSPA+, W-CDMA, CDMA2000, TD-SCDMA, GSM, GPRS, EDGE, and WiMAX.

In an embodiment, the baseband processor/processing engine communicates with RFIC module 110 to transmit or receive signals over the air interface to or from a base station of the cellular network. RFIC module 110 includes various mixed signal (e.g., Digital-to-Analog Converters (DACs), Analog-to-Digital Converters (ADCs)) and analog components (filters, mixers, power amplifier (PA), low noise amplifier (LNA), etc.) that provide at least one RF transmit chain and at least one RF receive chain.

In an embodiment, CP 108 and/or AP 102 implement a Non-Access Stratum (NAS)/Radio Resource Control RRC signaling and a control module and/or Packet Data Convergence Protocol (PDCP) modules that run aside or on top of LTE L2 protocols and below the IP protocol. 3GPP In-device coexistence (IDC) defined signaling relate in part but not limited to NAS/RRC protocols. In different embodiments, these modules can run on either AP 102 and/or CP 102.

GNSS module 104 includes one or more GNSS receivers, including, for example, a Global Position System (GPS) receiver, a GLONASS receiver, a Galileo receiver, and/or a Beidou receiver. In an embodiment, a GNSS receiver can include a GNSS radio frequency (RF) unit for receiving satellite signals and a GNSS processor for sampling the received satellite signals and using the samples to search for, acquire, and track satellites. The GNSS processor or another processor (located either in GNSS module 104 or AP 102) can provide higher-level navigation solutions (e.g., position/velocity calculation).

WLAN/BT module 114 implements a WLAN protocol stack and/or a BT protocol stack, which perform physical layer (Layer 1 (L1)) and L2 WLAN and BT functions respectively. As described above, in one embodiment, the WLAN/BT module 114 is coupled to cellular communications module 106 via interface 112. In an embodiment, interface 112 includes a Global Coexistence Interface (GCI) used to exchange information between WLAN/BT module 114 and cellular communications module 106 to ensure coexistence of the communication technologies being used by WLAN/BT module 114 and cellular communications module 106. For example, interface 112 can be used to exchange information for the coexistence of LTE communications enabled by cellular communications module 106 and WLAN/BT communications enabled WLAN/BT module 114.

Due to their physical proximity, potential spectral closeness (e.g., WLAN and BT can both operate in the 2.4 GHZ Industrial, Scientific, and Medical (ISM) band), and/or imperfect RF filtering (e.g., due to temperature drift), the different radio technologies supported by cellular communications module 106, GNSS module 104, and WLAN/BT module 114 may need to coexist with one another within communications device 100. In-device coexistence (IDC) interference refers to interference caused/suffered by a radio technology communications module (e.g., cellular communications module 106) due to its coexistence within the same device (e.g., communications device 100) with another radio technology communications module (e.g., WLAN/BT module 114).

IDC interference can in some cases be managed internally within communications device 100. In other cases, communications device 100 can benefit from cellular network assistance to remedy the IDC interference. In Release 11 of the Long Term Evolution (LTE) standard, the 3^{rd} Generation Partnership Project (3GPP) released an IDC specification (which is incorporated herein by reference) that describes general UE-eNB signaling requirements and UE measurement requirements for the purpose of enabling network-assisted IDC solutions (hereinafter IDC solutions). However, the IDC specification does not specify the design and implementation details of potential IDC solutions, the limitations of the IDC signaling and IDC solutions in the face of ongoing coexistence RF interference, how and when to trigger IDC solutions, and how to resolve IDC interference with or without IDC solutions. Embodiments, as further described below, address these implementation details to enable IDC solutions.

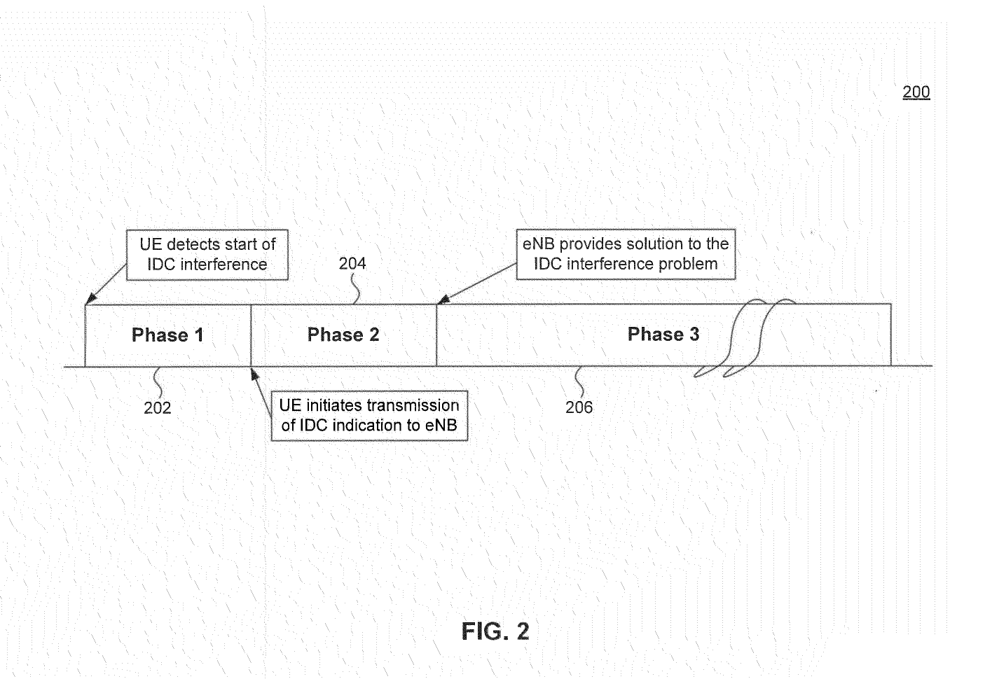

FIG. 2 illustrates an IDC interference related process 200 defined by the 3GPP. Process 200 can be performed by a UE such as cellular communications module 106 of communications device 100, to inform a cellular network about an IDC interference problem and to receive an IDC solution from the cellular network to resolve the IDC interference problem.

As shown in FIG. 2, process 200 includes three phases 202, 204, and 206. At the beginning of phase 202, the UE (e.g., cellular communications module 106) detects the start of IDC interference. The IDC interference can be interference caused by the cellular communications module (e.g., cellular communications module 106) on one or more collocated communications modules (e.g., GNSS module 104, WLAN/BT module 114), or vice versa. During phase 202, the UE performs IDC measurements as specified by the IDC specification. For example, the IDC specification specifies that the UE should perform Radio Resource Monitoring (RRM) measurements, Radio Link Monitoring (RLM) monitoring, and Channel State Information (CSI) measurements during phase 202.

At the beginning of phase 204, the UE initiates transmission of an IDC indication to its serving eNB. Some of the IDC indication is transmitted using dedicated Radio Resource Control (RRC) signaling to the eNB. The IDC indication includes some of the IDC measurements performed by the UE in phase 202 and assistance information for the eNB to determine an appropriate IDC solution for the IDC interference problem. For example, the assistance information can include unusable frequencies (e.g., list of frequencies suffering ongoing interference), and the device-suggested IDC solutions and solution parameters based on the device-side application scenario (the type of applications/services being enabled by the different collocated radio technology communications modules) under which the IDC interference is occurring.

At the beginning of phase 206, the eNB provides an IDC solution to the IDC interference problem signaled in phase 204 in the IDC indication. The eNB-provided IDC solution or parameters may or may not be relevant to device-suggested IDC solution. The IDC solution is transmitted using dedicated RRC signaling, for example, to the UE, or through eNB-controlled resource allocation or handoff commands, etc. The UE receives the IDC solution and applies the IDC solution in phase 206 to remedy the IDC interference problem. The IDC solution can include adjusting operation parameters of the UE used in communication with the eNB.

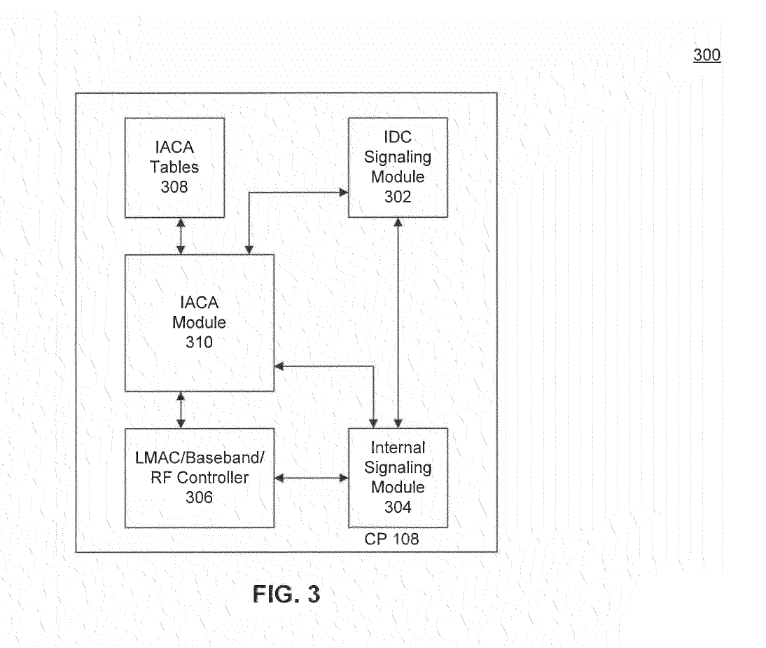

FIG. 3 illustrates an example communications processor (CP) 300 according to an embodiment. Example CP 300 is provided for the purpose of illustration only and is not limiting of embodiments. CP 300 is an embodiment of CP 108 of cellular communications module 106 described with reference to FIG. 1 above. As further described below, CP 300 can enable cellular communications module 106 to perform an IDC Advanced Coexistence Algorithm (IACA), which allows cellular communications module 106 to coexist with other communications modules, such as WLAN/BT module 114 and/or GNSS module 104, within communications device 100. As shown in FIG. 3, CP 300 includes an IDC signaling module 302, an internal signaling module 304, a Lower Medium Access Control (LMAC)/Baseband/RF Controller module 306, IACA tables 308, and an IACA module 310.

In an embodiment, LMAC/Baseband/RF Controller module 306 is configured to detect IDC interference based on measurements performed by LMAC/Baseband/RF Controller module 306 using RFIC module 110. The IDC interference can be interference caused by cellular communications module 106 on one or more collocated communications modules (e.g., GNSS module 104, WLAN/BT module 114), or vice versa. For example, LMAC/Baseband/RF Controller module 306 can determine from the measurements that cellular communications module 106 is interfering with the reception of WLAN/BT module 114.

In an embodiment, LMAC/Baseband/RF Controller module 306 and/or IACA module 310 determine whether the detected IDC interference can be remedied using an internal solution only. As used herein, an internal solution refers to a solution, associated with internal signaling processes between coexisting LTE/WLAN/BT/GNSS modules across the interfaces, to remedy IDC interference without involving assistance from the cellular network. For example, the internal solution can include applying coexistence algorithms such as described in U.S. application Ser. No. 13/677,211, filed Nov. 14, 2012, titled “Multi-Radio Coexistence,” and/or U.S. application No. TBD, filed ______, titled “Cellular-to-GNSS Fine Time Assistance and Power Amplifier (PA) Blanking,” both of which are incorporated herein by reference in their entireties. In an embodiment, the internal solution is selected using a look up table, such as Table 1 described below, based on a current application scenario of communications device 100.

If the detected IDC interference can be resolved using an internal solution only, then one or more internal solutions are selected and applied by IACA module 310. Otherwise, LMAC/Baseband/RF Controller module 306 and/or IACA module 310 trigger an IDC solution to request network assistance to resolve the detected IDC interference. IACA module 310 may still select and apply one or more internal solutions in this case too.

In an embodiment, LMAC/Baseband/RF Controller module 306, upon triggering the IDC solution, performs IDC measurements as specified by the IDC specification, including RRM, RLM, and CSI measurements. In another embodiment, before performing the IDC measurements, LMAC/Baseband/RF Controller module 306, via internal signaling module 304, signals any active collocated communications module (e.g., WLAN/BT module 114) to stop transmitting during the performance of the IDC measurements. This embodiment may involve an internal solution to schedule such a transmission (stop) time. As such, embodiments address the IDC specification requirement that IDC measurements be interference-free. In another embodiment, LMAC/Baseband/RF Controller module 306 may employ advanced interference cancellation/detection/mitigation techniques during the IDC measurements. Similarly, in one embodiment, before performance of the IDC signaling, LMAC/Baseband/RF Controller module 306 may similarly conduct the internal solution to enable IDC signaling module 304, and to schedule/protect the signaling messages' transmission/reception time with WLAN/BT/GNSS causing coexistence RF interference. In an embodiment, internal signaling module 304 uses interfaces 122 and 112 to communicate directly with GNSS module 104 and WLAN/BT module 114, respectively.

IACA module 310 is configured to trigger and/or determine a preferred IDC solution and the associated parameters in the IDC signaling for the IDC interference based on operation parameters of communications device 100. The operation parameters of communications device 100 include or are derived from a current application scenario of communications device 100 and associated connection configurations of cellular communications module 106 and of one or more collocated communications modules (e.g., WLAN/BT module 114, GNSS module 104) to support the current scenario. Example application scenarios and associated connection configurations are provided below. In an embodiment, IACA module 310 communicates with the one or more collocated communications modules and/or AP 102 to determine the current application scenario and associated connection configurations.

As further described below, the preferred IDC solution can include, without limitation, one or more of: time fitting of communication event patterns of cellular communications module 106 and one or more collocated communications modules (e.g., WLAN/BT module 114, GNSS module 104); configuring an inactivity cycle pattern of cellular communications module 106; avoiding scheduling cellular communications module 106 on resource blocks with high IDC interference; autonomously denying by cellular communications module 106 a scheduled transmission opportunity; and performing inter-frequency handover by cellular communications module 106.

In an embodiment, IACA module 310 determines the preferred IDC solution, using a look up table of IACA tables 308, based on the current application scenario and the associated connection configurations. Tables 1 and 2 below illustrate example look up tables that can be used by IACA module 310 to determine a preferred IDC solution (as well as an internal solution) based on operation parameters of communications device 100. Tables 1 and 2 can be generated offline using accurate and comprehensive offline analysis of coexisting radio technology communications modules under various applications scenarios and associated connection configurations. They can also be adapted or calibrated based on real-time online measurements or configuration changes. Not shown here, IACA tables 308 may also include a Coexistence Policy Lookup Table and/or an RF Interference Table, which are described in U.S. application Ser. No. 13/677,211, filed Nov. 14, 2012, titled “Multi-Radio Coexistence,” which is incorporated herein by reference in its entirety. The application of any adaptation to those table formats or specific table entries is within the scope of embodiments.

Specifically, Table 1 specifies the applicability of IDC solutions and internal solutions for various application scenarios and associated connection configurations. A question mark in the table indicates that the solution may or may not be used pending further analysis. For example, the first entry of Table 1 shows that an IDC solution based on a Hybrid Automatic Repeat Request (HARQ) bitmap/subframe reservation pattern, Discontinuous Reception (DRX) pattern configuration, Resource Block (RB) selection, autonomous denial, or inter-frequency handover can be used when an application scenario of communications device 100 comprises a Voice over LTE (VoLTE) or Video Over LTE (V2oLTE) session (using cellular communications module 106) and a BT voice connection with a headphone (using WLAN/BT module 114), with the application scenario being supported by connection configurations including Semi-Persistent Scheduling (SPS)/HARQ bitmap for the VoLTE/V2oLTE session and eSCO (extended Synchronous Connection) for the BT voice connection. The first entry further shows that of three internal solutions known as Dynamic Coexistence Algorithm (DCA), Fine Time Assistance (FTA), and Basic Coexistence Arbitration (BCA), DCA and/or BCA can be used in this application scenario. Details of the DCA, FTA, and BCA algorithms can be found in U.S. application Ser. No. 13/677,211, filed Nov. 14, 2012, titled “Multi-Radio Coexistence,” and/or U.S. application No. TBD, filed ______, titled “Cellular-to-GNSS Fine Time Assistance and Power Amplifier (PA) Blanking,” both of which are incorporated herein by reference in their entireties.

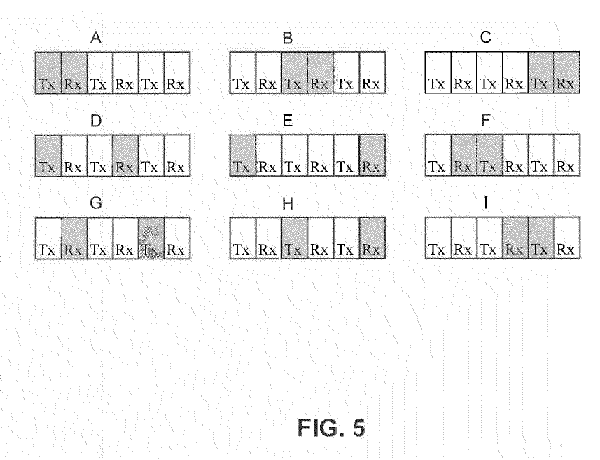

In the case that a HARQ bitmap/subframe reservation pattern IDC solution is used, Table 2 further specifies, based on the LTE frame configuration and the BT configuration parameters, a potential LTE HARQ bitmap/subframe reservation pattern that can be used by cellular communications module 106 to resolve the IDC interference with WLAN/BT module 114. For example, the fourth entry of Table 2 indicates that for an LTE frame configuration of TDD (Time Division Duplexing) Frame Configuration Type 2 (FC2) and a BT TX-RX pattern of “ABCGABCA” (FIG. 5 shows the BT TX-RX modes (A, B, C, . . . , I) each over a 6 Bluetooth slots) a potential LTE HARQ bitmap/subframe reservation pattern is “1111110100,” where a “1” indicates that cellular communications module 106 can transmit during the corresponding radio subframe and a “0” indicates that cellular communications module 106 does not transmit during the corresponding radio subframe. The table entry further indicates a T_eSCO offset (e.g., 2.375 milliseconds), which should be adopted by BT relative to the LTE frame boundary. As further indicated in the table entry, this timing fitting of communication event patterns of cellular communications module 106 and WLAN/BT module 114 (in this case only BT is used) results in no collision between LTE and BT when used with a period of 30 milliseconds.

TABLE 1

| | | Applicability of IACA Coexistence Solutions | | | | | |
|---|---|---|---|---|---|---|---|
| | | 1. HARQ | | | | | |
| | | bitmap/ | | 3. Resource | 4. Autonomous | | |
| | | subframe | | Block | denial (and | | DCA/ |
| Application | Connection | reservation | 2. DRX | (RB) | Power | 5. Inter-freq. | FTA/ |
| scenarios | configurations | pattern | pattern | selection | Control) | handover | BCA |
| 1. LTE | 1. SPS/HARQ | Y | ? | Y | Y (2^{nd} last | Y (last | DCA/ |
| VoLTE + BT | bitmap + eSCO | | | | choice) | choice) | BCA |
| headphone | [+ACL] | | | | | | |
| (voice) | | | | | | | |
| 2. LTE | 2. SPS/HARQ | Y | Y | Y | Y (2^{nd} last | Y (last | DCA/ |
| V2oLTE + BT | bitmap + eSCO | | | | choice) | choice) | BCA |
| headphone | or A2DP [+ACL] | | | | | | |
| (multimedia | | | | | | | |
| audio | | | | | | | |
| streaming) | | | | | | | |
| 3. LTE web | 3. Dynamic | | Y | Y | Y (2^{nd} last | Y (last | DCA/ |
| browsing + | scheduling/ | | | | choice) | choice) | BCA |
| WLAN | DRX + DCF | | | | | | |
| SoftAP | A-MPDU | | | | | | |
| (tethering) | | | | | | | |
| 4. LTE web | 4. DRX/ | Y | ? | Y | Y (2^{nd} last | Y (last | DCA/ |
| browsing/ | dynamic | | | | choice) | choice) | BCA |
| V2oLTE + | scheduling/SPS/ | | | | | | |
| WLAN | HARQ | | | | | | |
| SoftAP (for | bitmap + DCF | | | | | | |
| web and/or | WMM/A-MPDU + | | | | | | |
| video) + BT | eSCO and/or | | | | | | |
| headphone | A2DP [+ACL] | | | | | | |
| (for voice | | | | | | | |
| and/or music | | | | | | | |
| streaming) | | | | | | | |
| 5. LTE | 5. SPS/HARQ | Y | ? | Y | Y (2^{nd} last | Y (last | DCA/ |
| VoLTE + BT | bitmap + eSCO | | | | choice) | choice) | BCA |
| headphone | [+ACL] + DCF | | | | | | |
| (voice) + WLAN | WMM/A-MPDU | | | | | | |
| offload (video | | | | | | | |
| and/or web) | | | | | | | |
| 6. any of the | 6. DRX/ | Y (excluding | Y | Y | Y (2^{nd} last | Y (last | DCA/ |
| above + GNSS | dynamic | scenario 3) | (depends | | choice) | choice) | BCA/ |
| receiver | scheduling/SPS/ | | on | | | | FTA |
| | HARQ | | scenarios | | | | |
| | bitmap + DCF | | 1, 4, 5) | | | | |
| | WMM/A-MPDU + | | | | | | |
| | eSCO and/or A2DP | | | | | | |
| | [+ACL] + FTA/PA | | | | | | |
| | Blanking | | | | | | |
| 7. random, | 7. LTE | | | | Y | | DCA/ |
| mission/time | network access + | | | | | | BCA/ |
| critical, | BT connection | | | | | | FTA |
| irregular | setup (ACL, | | | | | | |
| BT/WLAN/ | paging/inquiry) + | | | | | | |
| LTE/GNSS | WLAN network | | | | | | |
| applications | access + GNSS | | | | | | |
| (connection | initial acquisition | | | | | | |
| setup, | | | | | | | |
| paging/scan/ | | | | | | | |
| inquiry) | | | | | | | |

TABLE 2

| | | BT Master, eSCO (S4 EV3) | | |
|---|---|---|---|---|
| LTE Frame | LTE HARQ | Frame alignment/ | | |
| Configuration | bitmap/subframe | T_eSCO offset (delay) | | |
| (as input) | reservation pattern | (ms) | TX-RX bitmap pattern | Notes |
| FDD | 11001100 | 1-0.625 | BBCCCCAAAAA . . . | Period = 120 ms, no |
| | | | | collision, HARQ |
| | | | | compliant |
| TDD FC0 | No need | 4.375 | ABCF | Period = 15 ms or |
| (SSFC-5 or - | | | | 6*T_eSCO, no |
| 7) | | | | collision, HARQ |
| | | | | compliant |
| TDD FC1 | No need | 4.375 | ABCG | Same as above |
| TDD FC2 | 1111110100 | 2.375 | ABCGABCA | Period = 30 ms, no |
| | | | | collision, HARQ |
| | | | | compliant |
| TDD FC2 | 1111101111 | 0 | CBABCBAB | Same as above |
| | 1111111111 | | | |
| | 0111111111 | | | |
| TDD FC3 | 1111111101 | 4.375 | AACCGBBF | Same as above |
| TDD FC4 | 1111111001 | 3.375 | AACCABBG | Same as above |
| TDD FC4 | 1111110111 | 1 | CBGBAGAA | Same as above |
| | 1011110111 | | | |
| | 1111111011 | | | |
| TDD FC5 | 1111010010 | 4.375 | ABCBABAF | Same as above |
| TDD FC5 | 1111101011 | 0 | CBABABAA | Same as above |
| | 1111101111 | | | |
| | 0111110111 | | | |
| TDD FC6 | 1110011110 | 4.375 | ABCB BBAG AAAA | Period = 60 ms, no |
| | 0111011011 | | CBCC | collision, HARQ |
| | 0011111001 | | | compliant |
| | 1011101101 | | | |
| | 1101100111 | | | |
| | 1100110110 | | | |

In an embodiment, one or more IDC solutions can be used for a particular application scenario and associated connection configurations. For example, as described above, a HARQ bitmap/subframe reservation pattern based solution can be used to avoid collisions between LTE transmit events and BT communication events that follow a particular TX-RX pattern. Generally, this IDC solution can be used for application scenarios comprising VoLTE and BT (eSCO) voice streaming for both Frequency Division Duplexing (FDD) and TDD LTE frame configurations. Other IDC solutions can also be used as further described below.

A DRX pattern configuration based IDC solution includes configuring a known DRX pattern for the UE to accommodate in the time domain communication events of collocated communications modules. DRX is an LTE feature that allows a UE to discontinue monitoring a downlink control channel in a specified period of time (DRX interval). The DRX interval is determined by the network, which does not schedule any downlink transmissions to the UE during this interval. The UE can thus enter into a DRX inactive state (e.g., sleep state), if desired, during which the UE stops monitoring the downlink control channel. In an embodiment, configuring a DRX pattern for the UE includes configuring a repetition pattern of a DRX cycle (which includes the DRX interval and an ON duration during the UE should monitor the downlink control channel) and a duration of the DRX cycle. For example, in an embodiment, a DRX cycle of 128 msec (e.g., 68 msec for the DRX interval and 60 msec for the ON duration) can be repeated according to a known pattern and used for an application scenario comprising LTE-WLAN offload of multimedia services (multimedia services offloaded from LTE to WLAN), or V2oLTE and BT Advanced Audio Distribution Profile (A2DP), for example. A longer DRX cycle can be used for an application scenario comprising LTE web browsing and WLAN Soft Access Point (AP).

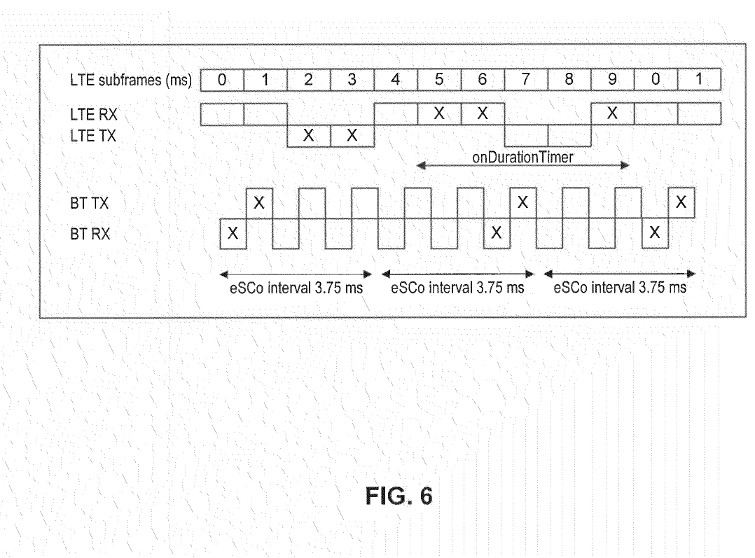

FIG. 6 illustrates an example DRX pattern configuration based IDC solution for an example LTE and BT application scenario according to an embodiment. Specifically, the example DRX pattern configuration can be used for an application scenario comprising VoLTE (TDD LTE frame configuration) and BT (eSCO) voice streaming. As shown in FIG. 6, the DRX cycle is 10 msec long, including an ON duration of 5 LTE subframes (5 msec) and a DRX interval of 5 LTE subframes. Within the ON duration, the UE receives the downlink control channel over 3 subframes only (the subframes numbered 5, 6, and 9), during which BT does not transmit. In the DRX interval, the UE does not receive but transmits during scheduled uplink transmission opportunities (the subframes numbered 2 and 3). BT is silent during the LTE scheduled uplink transmission opportunities and active outside of the LTE scheduled uplink transmission opportunities.

A resource block (RB) selection based IDC solution includes avoiding scheduling transmissions by the UE (e.g., cellular communications module 106) on resource blocks (RBs) (e.g., sub-carriers) with high IDC interference. In an embodiment, the RBs to be avoided are determined based on IDC measurements (e.g., RRM, RLM, CSI) performed by LMAC/Baseband/RF Controller module 306. In an embodiment, the IDC measurements are used as inputs to an RF interference look up table of IACA tables 308 to identify the RBs to be avoided.

An autonomous denial based IDC solution includes the UE (e.g., cellular communications module 106) autonomously (without network request/instruction) denying a scheduled uplink transmission opportunity (e.g., a periodically scheduled uplink transmission slot) to the cellular network. In an embodiment, this IDC solution is used to accommodate random (e.g., not anticipated) receive event indications from collocated communications modules. For example, the random receive event indication can correspond to a BT connection setup receive event, a WLAN network access receive event, or a GNSS initial acquisition receive event. In an embodiment, the random receive event indication corresponds to a receive event that is occurring more than a UE-eNB round-trip-delay (RTD) in the future such that the UE can notify the eNB of its autonomous denial.

An inter-frequency handover based IDC solution includes the UE being handed over from a current serving eNB to a target eNB to reduce IDC interference with collocated communications module. For example, in an embodiment, IDC interference between cellular communications module 106 operating close to the 2.4 GHz ISM where WLAN/BT module 114 (for BT activity) also operates can result in cellular communications module 106 being handed over to another eNB operating away from the ISM band. In an embodiment, the target eNB is notified when the handover occurs of the IDC problem that triggered the handover to avoid a ping-pong scenario where the UE is handed over back and forth between eNBs.

Returning to FIG. 3, after determining a preferred IDC solution as described above, IACA module 310 forwards the preferred IDC solution to IDC signaling module 302. IDC signaling module 302 generates an IDC indication, which includes the preferred IDC solution and the IDC measurements performed by LMAC/Baseband/RF Controller module 306, and transmits the IDC indication to the cellular network. In an embodiment, the IDC indication includes device-side assistance information, such as the applicable scenario or interference situation at the device.

The cellular network processes the IDC indication to determine a network-identified IDC solution and transmits the network-identified solution to IDC signaling module 302. The network-identified IDC solution can be the preferred IDC solution identified by the UE or another IDC solution determined by the cellular network. In an embodiment, the network-identified IDC solution is the preferred IDC solution identified by the UE, whenever the preferred IDC solution can be accommodated by the cellular network given the service requirements of other UEs being served by the cellular network.

IDC signaling module 302 receives the network-identified IDC solution and forwards it to IACA module 310. IACA module 310 applies the network-identified IDC solution to remedy the IDC interference. In another embodiment, IACA module 310 may modify, re-negotiate with the cellular network, or ignore the network-identified IDC solution. In an embodiment, IACA module 310, via internal signaling module 304, notifies the involved collocated communications modules of the network-identified IDC solution and of any parameter adjustment needed to enable the IDC solution, before applying the network-identified IDC solution. For example, in the above described example involving a HARQ bitmap/subframe reservation pattern based IDC solution, IACA module 310 notifies WLAN/BT module 114 of the T_eSCO offset that needs to be adopted by BT relative to the LTE frame boundary to enable the IDC solution.

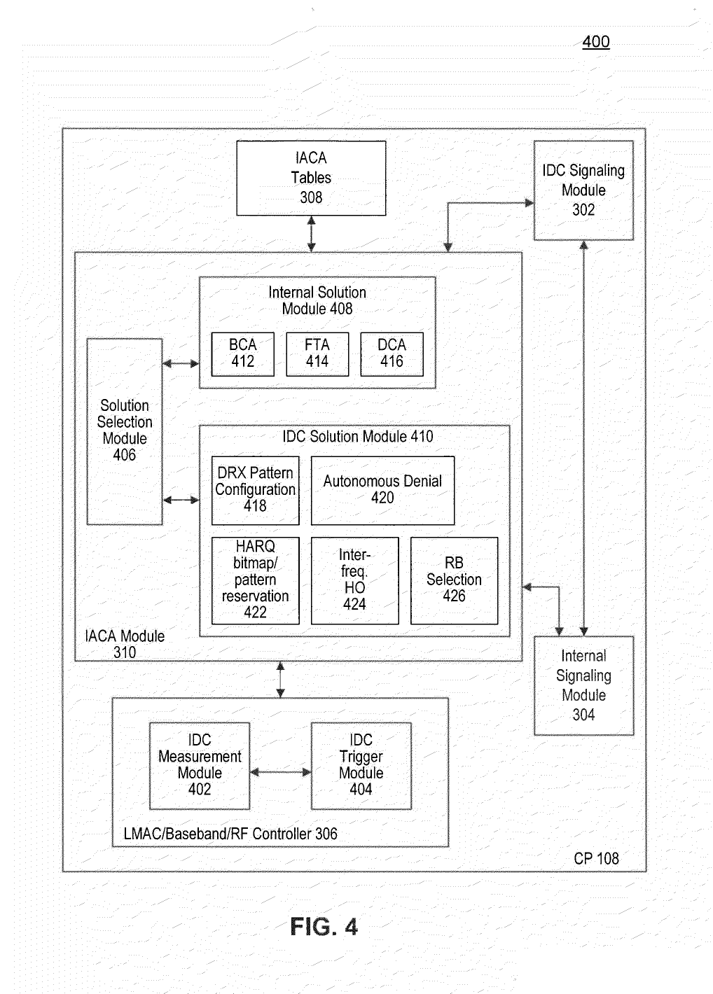

FIG. 4 illustrates another example communications processor (CP) 400 according to an embodiment. Example CP 400 is provided for the purpose of illustration only and is not limiting of embodiments. CP 400 is an embodiment of CP 108 of cellular communications module 106 described with reference to FIG. 1 above and of CP 300 described with reference to FIG. 3 above. As further described below, CP 400 can enable cellular communications module 106 to perform IACA, which as described above allows cellular communications module 106 to coexist with other communications modules, such as WLAN/BT module 114 and/or GNSS module 104, within communications device 100.

As shown in FIG. 4, CP 400 includes an IDC signaling module 302; an internal signaling module 304; a LMAC/Baseband/RF Controller module 306, including an IDC measurement module 402 and an IDC trigger module 404; IACA tables 308; and an IACA module 310, including a solution selection module 406, an internal solution module 408, and an IDC solution module 410.

In an embodiment, IDC measurement module 402 is configured to perform IDC measurements using RFIC module 110 and to detect IDC interference based on the IDC measurements. When IDC interference is detected, solution selection module 406 is configured to determine whether the detected IDC interference can be remedied using an internal solution only. If so, then solution selection module 406 selects one or more internal solutions and instructs internal solution module 408 to apply the selected internal solutions. In an embodiment, internal solution module 408 includes a BCA module 412, an FTA module 414, and a DCA module 416 for performing the BCA, FTA, and DCA algorithms, respectively.

If solution selection module 406 determines that the IDC interference cannot be remedied with an internal solution only, solution selection module 406 notifies IDC trigger module 404 to trigger an IDC solution to request network assistance to resolve the detected IDC interference. In an embodiment, solution selection module 406 still selects one or more internal solutions to apply even if the IDC interference cannot be remedied with an internal solution only. IDC trigger module 404 triggers the IDC solution and requests that IDC measurement module 402 performs further IDC measurements as specified by the IDC specification, including RRM, RLM, and CSI measurements. The selected internal solution may interact with the selected IDC solution through internal messaging, register/memory sharing, interrupts, or any other common software/hardware mechanisms for such a purpose.

Subsequently, solution selection module 406 determines the current application scenario of communications device 100 and the underlying connection configurations of cellular communications module 106 and the one or more collocated communications modules involved in the detected IDC interference, to support the current application scenario. In an embodiment, solution selection module 406 determines the current application scenario from AP 102 and the underlying connection configurations from AP 102, and/or the respective communications modules, and/or the collocated devices. For example, solution selection module 406 may determine from AP 102 that the current application scenario comprises a VoLTE session and a BT voice connection. For each of the applications (VoLTE and BT voice), solution selection module 406 communicates with the supporting communications module, etc., to retrieve any needed underlying connection configurations.

Based on the current application scenario and the associated connection configurations, solution selection module 406 determines one or more preferred IDC solutions. In an embodiment, solution selection module 406 determines the one or more preferred IDC solutions using a look up table (e.g., Table 1 and/or Table 2 described above) of IACA tables 308 based on the current application scenario and the associated connection configurations. Solution selection module 406 then notifies IDC signaling module 302 and internal signaling module 304 of the one or more preferred IDC solutions and their associated parameters.

As described above, IDC signaling module 302 generates an IDC indication, which includes the UE-side preferred IDC solution(s), assistance information (e.g., the interfered frequency list), and the IDC measurements performed by IDC measurement module 402, and transmits the IDC indication to the cellular network. The cellular network processes the IDC indication to determine a network-identified IDC solution and transmits the network-identified solution to IDC signaling module 302.

Upon receiving the network-identified IDC solution, IDC signaling module 302 forwards the network-identified IDC solution to solution selection module 406. Solution selection module 406 instructs IDC solution module 410 to apply the network-identified IDC solution, optionally with UE-side adjustment, further negotiation between the UE and the network, or at the UE that meets the solution requirements. In an embodiment, IDC solution module 410 includes a DRX pattern configuration module 418, an autonomous denial module 420, a HARQ bitmap/subframe reservation pattern module 422, an inter-frequency handover module 424, and a RB selection module 426 for applying respective IDC solutions as described above. In another embodiment, solution selection module 406 may determine whether or not to apply the network-identified IDC solution (when the UE has a choice regarding whether or not to apply the network-identified IDC solution) and may decide not to apply the network-identified IDC solution.

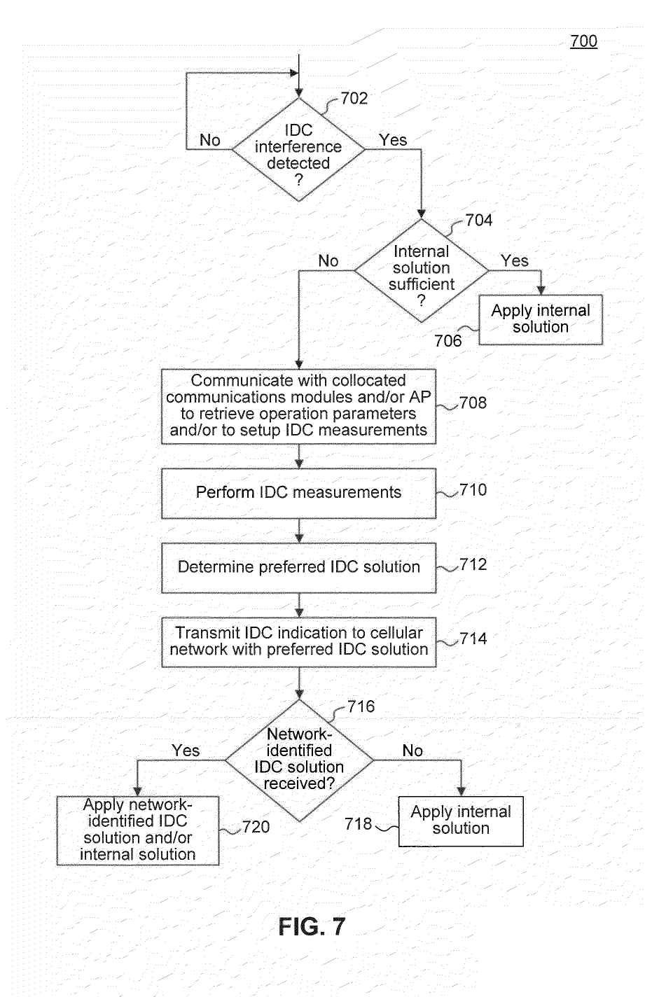

FIG. 7 is an example process 700 according to an embodiment. Example process 700 is provided for the purpose of illustration only and is not limiting of embodiments. Process 700 can be performed by cellular communications module, such as cellular communications module 106, and more specifically by a communications processor, such as CP 300.

As shown in FIG. 7, process 700 begins in step 702, which includes determining whether or not IDC interference has been detected. In an embodiment, step 702 can be performed by LMAC/Baseband/RF Controller module 306 of CP 300. If no IDC interference has been detected, process 700 returns to step 702. Otherwise, process 700 proceeds to step 704, which includes determining whether or not an internal solution is sufficient to remedy the IDC interference. In an embodiment, step 704 can be performed by IACA module 310, and more specifically by solution selection module 406 of IACA module 310.

If an internal solution is sufficient, process 700 proceeds to step 706, which includes applying the internal solution. In an embodiment, step 706 can be performed by IACA module 310, and more specifically by internal solution module 408 of IACA module 310, optionally with the involvement of internal signaling module 304. If the internal solution is not sufficient, process 700 proceeds to step 708, which includes communicating with collocated communications module and/or the AP to retrieve operation parameters of the communications device and/or to setup IDC measurements.

As described above, the operation parameters of the communications device include a current application scenario and associated connection configurations of the cellular communications module and the one or more collocated communications modules involved in the detected IDC interference. In one embodiment, the setting up of the IDC measurements includes communicating with the one or more collocated communications module to request that they stop transmitting during IDC measurements to be performed. In another embodiment, the IDC measurements involve baseband level interference cancellation techniques to remove the coexistence interference from the measurement results. In an embodiment, step 708 can be performed by IACA module 310, together with internal signaling module 304.

Subsequently, process 700 proceeds to step 710, which includes performing IDC measurements. In an embodiment, step 710 can be performed by LMAC/Baseband/RF Controller module 306. Then, step 712 includes determining a preferred IDC solution. In an embodiment, the preferred IDC solution is determined based on the retrieved operation parameters of the communications device using a look up table as described above. In an embodiment, step 710 can be performed by IACA module 310, and more specifically solution selection module 406 of IACA module 310.

Then, process 700 proceeds to step 714, which includes transmitting an IDC indication to the cellular network with the preferred IDC solution. In an embodiment, step 714 can be performed by IDC signaling module 302. Subsequently, step 716 includes determining whether or not a network-identified IDC solution has been received. If no network-identified IDC solution is received within a predetermined time from the IDC indication transmittal, process 700 proceeds to step 718, which includes applying the internal solution only. Otherwise, process 700 proceeds to step 720, which includes applying the network-identified IDC solution and/or the internal solution. In an embodiment, step 720 includes applying the network-identified solution only or the internal solution only.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

1. A communications device, comprising:
a first radio technology communications module; and
a second radio technology communications module,
wherein the first radio technology communications module is configured to detect in-device coexistence (IDC) interference and determine a preferred IDC solution for the IDC interference based on operation parameters of the communications device, and wherein the operation parameters include a current application scenario of the communications device and associated connection configurations of the first radio technology communications module and the second radio technology communications module to support the current application scenario.

2. The communications device of claim 1, wherein the first radio technology communications module includes a cellular communications module, and wherein the second radio technology communications module includes one of: a Wireless Local Area Network (WLAN) communications module, a Bluetooth (BT) communications module, and a Global Navigation Satellite System (GNSS) module.

3. (canceled)

4. The communications device of claim 1, wherein the first radio technology communications module is further configured to determine the preferred IDC solution, using a look up table, based on the current application scenario and the associated connection configurations.

5. The communications device of claim 1, wherein the preferred IDC solution includes one or more of: time fitting of communication event patterns of the first radio technology communications module and the second radio technology communications module; configuring an inactivity cycle pattern of the first radio technology communications module; avoiding scheduling the first radio technology communications module on resource blocks with high IDC interference; autonomously denying by the first radio technology communications module a scheduled transmission opportunity; and performing inter-frequency handover by the first radio technology communications module.

6. The communications device of claim 1, wherein the first radio technology communications module is further configured to transmit an IDC indication including the preferred IDC solution to an access point of the first radio technology.

7. The communications device of claim 6, wherein the first radio technology communications module includes a cellular communications module, and wherein the access point includes a base station.

8. The communications device of claim 6, wherein the first radio technology communications module is further configured to receive, in response to the IDC indication, a network-identified IDC solution and to apply the network-identified IDC solution to reduce the IDC interference.

9. The communications device of claim 1, wherein the first radio technology communications module is further configured to determine whether or not an internal solution for the IDC interference remedies the IDC interference; and, if the internal solution is remedies the IDC interference, to apply the internal solution without determining the preferred IDC solution.

10. The communications device of claim 1, wherein the first radio technology communications module is further configured to perform IDC measurements after detecting the IDC interference.

11. The communications device of claim 10, wherein the first radio technology communications module is further configured to instruct the second radio technology communications module to schedule transmission and reception during the performance of the IDC measurements.

12. The communications device of claim 10, wherein the first radio technology communications module is further configured to cancel out the IDC interference from the second technology communications module.

13. A method for reducing in-device coexistence (IDC) interference due to the coexistence of two or more radio technology communications modules in a communications device, comprising:
detecting in-device coexistence (IDC) interference;
determining a preferred IDC solution for the IDC interference based on operation parameters of the communications device, wherein the operation parameters include a current application scenario of the communications device and associated connection configurations of the two or more radio technology communications module to support the current application scenario; and
transmitting an IDC indication including the preferred IDC solution to a base station.

14. The method of claim 13, wherein the two or more radio technology communications modules include two or more of: a cellular communications module, a Wireless Local Area Network (WLAN) communications module, a Bluetooth (BT) communications module, and a Global Navigation Satellite System (GNSS) module.

15. (canceled)

16. The method of claim 13, further comprising:
determining the preferred IDC solution, using one or more look up tables, based on the current application scenario and the associated connection configurations.

17. A method for reducing in-device coexistence (IDC) interference in a communications device that includes a first radio technology communications module and a second radio technology communications module, comprising:
determining whether or not an internal solution remedies the IDC interference;
if the internal solution remedies the IDC interference, applying the internal solution;
if the internal solution does not remedy the IDC interference,
determining a preferred IDC solution for the IDC interference based on operation parameters of the communications device, wherein the operation parameters include a current application scenario of the communications device and associated connection configurations of the first radio technology communications module and the second radio technology communications module to support the current application scenario; and
transmitting an IDC indication including the preferred IDC solution to a base station.

18. The method of claim 17, wherein, if the internal solution does not remedy the IDC interference, the method further comprises:
receiving, in response to the IDC indication, a network-identified IDC solution; and
applying one or more of the internal solution and the network-identified IDC solution to reduce the IDC interference.

19. The method of claim 18, further comprising:
adjusting the network-identified IDC solution, wherein adjusting the network-identified IDC solutions comprises re-negotiating the network-identified IDC solution with the base station.

20. The method of claim 19, further comprising:
sending the network-identified IDC solutions to a collocated device.

21. The method of claim 17, wherein the IDC interference includes interference due to the coexistence of the first radio technology communications module and the second radio technology communications module in the communications device.

22. (canceled)

23. The method of claim 13, further comprising:
receiving, in response to the IDC indication, a network-identified IDC solution; and
applying the network-identified IDC solution to reduce the IDC interference.

24. The method of claim 23, further comprising:
adjusting the network-identified IDC solution, wherein the adjusting the network-identified IDC solution comprises re-negotiating the network-identified IDC solution with the base station.

25. The method of claim 13, further comprising:
performing IDC measurements after detecting the IDC interference.
